(19) United States
(12) Patent Application Publication
(10) Pub. No.: US 2011/0025647 A1
(43) Pub. Date: Feb. 3, 2011

(54) Display Filter And Display Device Having The Same

(75) Inventors: Dong Hyun Park, ChungCheongNam-Do (KR); Ji Young Kim, ChungCheongNam-Do (KR); Dae Chul Park, ChungCheongNam-Do (KR); Cheol Hee Park, ChungCheongNam-Do (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SAMSUNG CORNING PRECISION MATERIALS CO., LTD., Gyeongsangbuk-do (KR)

(21) Appl. No.: 12/849,323

(22) Filed: Aug. 3, 2010

(30) Foreign Application Priority Data
Aug. 3, 2009 (KR) 10-2009-0071292

(51) Int. Cl. G06F 3/042; G02B 5/22

(52) U.S. Cl. 345/175; 359/359

(57) ABSTRACT

A display filter functions not only to block unnecessary radiation emitted from a display device but also to allow Infrared (NIR) radiation emitted from the display device to be used as a user interface signal. The display filter includes a near-infrared radiation blocking layer which absorbs near-infrared radiation emitted from the display device. The near-infrared radiation blocking layer contains 1.5% by weight of a di-immonium-based colorant that absorbs the near-infrared radiation.

### CROSS REFERENCE TO RELATED APPLICATION

The present application claims priority from Korean Patent Application Number 10-2009-0071292 filed on Aug. 3, 2009, the entire contents of which application are incorporated herein for all purposes by this reference.

### BACKGROUND OF THE INVENTION

1. Field of the Invention

The present invention relates to a display filter which functions not only to block unnecessary radiation emitted from a display device but also to allow Near-Infrared (NIR) radiation emitted from the display device to be used as a user interface signal, and to a display device having the same.

2. Description of Related Art

In response to the emergence of the advanced information society, components and devices in the field of photo-electronics have been significantly improved and rapidly distributed. Among them, display devices, which display images, have been widely distributed for use in TVs, Personal Computer (PC) monitors, and the like. Moreover, attempts are underway to simultaneously increase the size and reduce the thickness of such display devices.

A Plasma Display Panel (PDP) device is gaining attention since it can have a large size and a thin profile when compared to a Cathode Ray Tube (CRT) device.

The PDP device displays an image using gas discharge, and has excellent display quality, for example, in relation to display capacity, luminance, contrast, after-image characteristics, viewing angle, and the like. In addition, the PDP device is a light-emitting display device that can have a large size and a thin profile, and is currently considered to be suitable to use as a high quality digital TV.

Such a PDP device generates electric discharge in the gas between electrodes by applying a direct or alternating voltage to the electrodes. The electric discharge is accompanied by Ultraviolet (UV) radiation, which in turn activates phosphor, thereby emitting light. However, the PDP device inherently has drawbacks, such as a large amount of Electromagnetic (EM) radiation and Near-Infrared (NIR) radiation emitted therefrom, high reflection, and orange light emitted from the gas contained therein, such as He or Xe, which results in color purity inferior to that of a CRT device. In addition, EM radiation and NIR radiation are harmful to the human body and may cause precision equipment, such as mobile phones and remote controls, to malfunction.

Therefore, there is a demand to reduce the emission of EM radiation and NIR radiation from PDP devices below a certain value. For this, the PDP device is provided with a PDP filter, which has a variety of functions, such as EM radiation blocking, NIR radiation blocking, prevention of reflection of external light from the surface, and/or color purity improvement, in order to block EM radiation and NIR radiation, reduce the reflection of light, and improve color purity.

Recently, a user interface device, for example, a touch screen, is widely used in various devices, such as a mobile phone, a Personal Digital Assistant (PDA), a Portable Media Player (PMP), an MPEG audio-layer 3 Player (MP3), a wireless tablet, and a kiosk. As an interface device which allows a user to select a desired program or film while watching a screen, such a touch screen will be used in more devices.

However, conventional touch screen technology uses a piezoelectric element, which converts an input signal in the form of pressure, into an electrical signal. In this technology, when the user touches the touch screen, coordinate data which are selected by a user, are inputted in the form of an electrical signal. In such conventional touch screen technology using the piezoelectric element, the user may operate the touch screen by applying relatively excessive pressure thereto, when the pressure sensitivity of the piezoelectric element is bad or the touch screen malfunctions. Considering the structural characteristics of the PDP, which is vulnerable to pressure or external impact, the PDP to which the touch screen technology is applied may be easily damaged or be caused to severely malfunction.

In order to solve this problem, IR touch screen technology in a PDP TV was proposed, as disclosed in Korean Patent Application Publication No. 1998-0041328 (hereinafter, referred to as the “cited reference”). The cited reference discloses a structure that includes vertical and horizontal IR signal generators, vertical and horizontal IR signal receivers, a controller, a coordinate calculator, and an interface. The vertical and horizontal IR signal generators may be light-emitting elements. The vertical IR signal receiver includes the same number of light-receiving elements as the light-emitting elements of the vertical IR signal generator. The horizontal IR signal receiver includes the same number of light-receiving elements as the light-emitting elements of the horizontal IR signal generator. The controller controls the operation of the light-emitting elements. The coordinate calculator calculates coordinates based on detection signals from the light-receiving elements. The interface executes a command corresponding to the coordinates.

However, in the cited reference, the vertical IR signal generator, the horizontal IR signal generator, the vertical IR signal receiver, and the horizontal IR signal receiver, all have to be provided, thereby increasing manufacturing costs and complicating the manufacturing process.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide a display filter, which functions not only to block unnecessary radiation emitted from a display device but also to allow Near Infrared (NIR) radiation emitted from the display device to be used as user interface signals, and to a display device having the same.

In an aspect of the present invention, the display filter is used in a display device which can determine a touch position by detecting infrared radiation emitted from a display device, in order to allow near-infrared radiation emitted from the display device to be used as a user interface signal.

In an exemplary embodiment, the display filter includes a near-infrared blocking layer which absorbs infrared radiation emitted from the display device, in which the near-infrared radiation blocking layer contains 1.5% by weight of a di-immonium-based colorant that absorbs the near-infrared radiation.

In another exemplary embodiment, the near-infrared radiation blocking layer may transmit the near-infrared radiation emitted from the display device at a transmittance of 30% or more in a wavelength range around 850 nm and at a transmittance of 5% or less in a wavelength range of 950 nm or more.

In another aspect of the present invention, the display filter also includes a conductive mesh film which absorbs electromagnetic radiation emitted from the display device, the near-infrared blocking layer being an adhesive layer adhered to the conductive mesh film.

As set forth above, when NIR radiation is emitted from the display device, the display filter can advantageously block a portion of NIR radiation in a wavelength range that has a negative effect on the operation of mobile phones or remote controls by means of the NIR blocking layer containing the di-immonium-based NIR absorbing colorant, while allowing the other portion of NIR radiation in a wavelength range that has less effect on external devices to pass through. The passed portion of NIR radiation is used as a user interface signal.

In addition, the display filter can advantageously block NIR radiation in a wavelength range of 950 nm or more while allowing NIR radiation in a wavelength range of 850 nm to pass through by means of the NIR blocking layer with a transmittance of 30% or more in the wavelength range around 850 nm and a transmittance of 5% or less in the wavelength range of 950 nm or more. NIR radiation in the wavelength range of 850 nm is used as a user interface signal,

Furthermore, the display filter and the display device having the same can advantageously block Electromagnetic (EM) radiation, which could otherwise have a harmful effect on the human body, since the conductive mesh film, which blocks EM radiation emitted from the display device, is also provided.

The methods and apparatuses of the present invention have other features and advantages which will be apparent from, or are set forth in more detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a view showing an exemplary embodiment of a display filter according to the invention; and

FIG. 2 is a graph showing NIR transmission characteristics of the display filter according to the invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments that may be included within the spirit and scope of the invention as defined by the appended claims.

A display device according to the present invention detects infrared light emitted from the display module to determine a touch position. In order to detect the infrared light, the display device may include a detector such as a sensor, an IR camera, etc. The display module emits the infrared light such that it is uniformly distributed. Here, when an external object touches the display device at a certain position, the distribution of the infrared light is varied. The detector detects this variation in the distribution and thereby the display device can locate the touch. For example, display devices in Korean Patent Application Nos. 10-2008-0016713 and 10-2008-0120662 may be used as a display device of the present invention. The contents of these applications are incorporated herein by the reference.

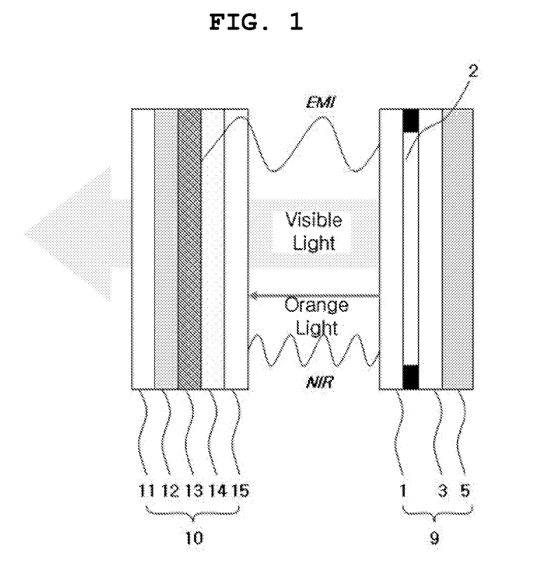

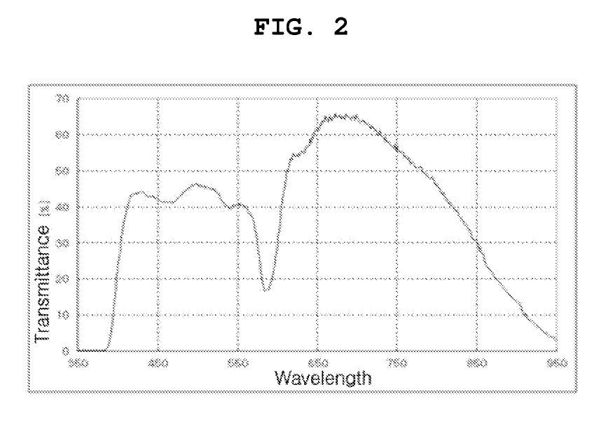

FIG. 1 is a view showing an exemplary embodiment of a display filter according to the invention, and FIG. 2 is a graph showing NIR transmission characteristics of the display filter according to the invention.

As shown in FIG. 1, a display device in this embodiment is a Plasma Display Panel (PDP) device. The PDP device includes discharge cells 2 between first and second substrates 1 and 3. Reference numeral 5 denotes a drive circuit board. The discharge cell 2 is filled with a discharge gas such as neon (Ne) or xenon (Xe). In addition, a fluorescent material is applied on the inner wall of the discharge cell 2 and the inner surface of the second substrate 3. When an alternating voltage is applied to the discharge cell 2, the fluorescent material is excited by ultraviolet radiation, which is created by gas discharge, thereby emitting visible light. The PDP device inherently emits not only visible light but also Electromagnetic (EM) radiation, Near-Infrared (NIR) radiation, and orange light having a wavelength ranging from 580 nm to 600 nm, which lowers color purity.

Referring to FIG. 1, the filter is provided in front of a display module 9. The display filter 10 of this embodiment includes an NIR blocking layer 15, an adhesive layer 14, and a conductive mesh film 13.

The NIR blocking layer 15 blocks NIR radiation, which would otherwise cause electronic devices, such as a mobile phone or a remote control, to malfunction. A band of infrared radiation which belongs to a wavelength range from 780 nm to 2000 nm, is generally referred to as near-infrared (NIR) radiation, since it is in the vicinity of a red wavelength range of visible light. The NIR blocking layer 15 contains an NIR radiation absorbing material that absorbs NIR radiation. For example, in the invention, the NIR blocking layer 15 can be a polymer resin film that contains a di-immonium-based NIR absorbing material in an amount of 1.5% by weight. Herein, the di-immonium-based NIR absorbing material can be CIR 1085™ di-immonium, which is available from Carlit in Japan.

Examples of the resin of the polymer resin film may include Polyethylene Terephthalate (PET), acryl, Polycarbonate (PC), urethane acrylate, polyester, epoxy acrylate, brominate acrylate, Polyvinyl Chloride (PVC), and the like.

As shown in FIG. 2, the NIR blocking layer 15 transmits the NIR radiation emitted from the display module 9 with a transmittance of 30% or more in the wavelength range of 850 nm and a transmittance of 5% or less in the wavelength range of 950 nm or more.

In one example, the NIR blocking layer 15 can include a color compensation colorant and/or a neon-cut colorant. The color compensation colorant can use a variety of colorants in order to increase the range of color reproduction of the display and improve the image visibility. Examples of the color compensation colorant include ORASOL Black™ pigment, which available from Ciba Specialty Chemicals in Japan, ORASOL Blue BL™ pigment, which is available from Ciba Specialty Chemicals in Japan, or ORASOL Red 2B™ pigment, which is available from Ciba Specialty Chemicals in Japan. Examples of the neon-cut colorant include TY102™ cyanine-based pigment, which available from Asahi Denka in Japan.

In another example, the NIR blocking layer 15 can be a coating layer, which is formed on a surface of a transparent support. The transparent support can be made of a heat strengthened glass or a transparent polymer resin. Examples of the polymer resin may include Polyethylene Terephthalate (PET), acryl, Polycarbonate (PC), urethane acrylate, polyester, epoxy acrylate, brominate acrylate, Polyvinyl Chloride (PVC), and the like.

The adhesive layer 14 allows the NIR blocking layer 15 and the conductive mesh film 13 to adhere to each other, and can be, for example, a Pressure Sensitive Adhesive (PSA). In one example, the adhesive layer 14 can contain a di-immonium-based NIR absorbing material in an amount of 1.5% by weight. Herein, the di-immonium-based NIR absorbing material can be CIR 1085™ di-immonium, which is available from Carlit in Japan.

According to this embodiment, the display filter 10 can achieve such NIR transmission characteristics that NIR radiation emitted from the display module 9 has a transmittance of 30% or more in the wavelength range around 850 nm and a transmittance of 5% or less in the wavelength range of 950 nm or more, without using the NIR blocking layer 15.

The conductive mesh film 13 blocks EM radiation, which could otherwise have a harmful effect on the human body. The conductive mesh film 13 can have a conductive mesh pattern of metal, and a transparent support on which the metal pattern is formed. Herein, the metal pattern can be made of Cu, Cr, Ni, Ag, Mo, W, Al, or the like, which has excellent electrical conductivity and can be easily formed.

The mesh filter 10 in this embodiment can be provided in the form of a film in which the NIR blocking layer 15, the adhesive layer 14, and the conductive mesh film 13 are integrated. In another embodiment, as shown in FIG. 1, the mesh filter 10 can also include an antireflection film 11 and a transparent substrate 12.

The antireflection film 11 improves visibility by reducing reflection of external light. The antireflection film 11 can be a single layer film having an optical thickness of, for example, ¼ of a wavelength of light. The single layer film can be formed of transparent fluorine-based polymer resin, magnesium fluoride, silicon-based resin, silicon oxide, or the like, which has a low refractive index of 1.5 or less.

Alternatively, the antireflection film 11 can have multi-layer structure that includes two or more layers of thin films having different refractive indices. The thin films can be made of an inorganic compound, such as metal oxide, fluoride, silicide, boride, carbide, nitride, sulfide, or the like, or an organic compound, such as silicon-based resin, acrylic resin, fluorine-based resin, or the like. The transparent substrate 12 is a substrate over which an optical films are laminated, and can be made of a heat strengthened glass or a transparent polymer resin.

Although only the PDP device has been used to illustrate a display device to which the display filter according to the invention is applied, the display filter according to the invention can also be applied to any other display devices such as a Liquid Crystal Display (LCD) and an Organic Light Emitting Display (OLED).

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A display filter used in a display device which can determine a touch position by detecting infrared radiation emitted from the display device, the display filter comprising:
a near-infrared radiation blocking layer which absorbs near-infrared radiation emitted from the display device,
wherein the near-infrared radiation blocking layer contains 1.5% by weight of a di-immonium-based colorant that absorbs the near-infrared radiation.

2. The display filter according to claim 1, wherein the near-infrared radiation blocking layer allows the near-infrared radiation emitted from the display device to have a transmittance of 30% or more in a wavelength range of 850 nm and a transmittance of 5% or less in a wavelength range of 950 nm or more.

3. The display filter according to claim 1, wherein the near-infrared radiation blocking layer comprises a polymer resin film that contains a near-infrared radiation absorbing colorant.

4. The display filter according to claim 1, wherein the near-infrared radiation blocking layer comprises a coating layer which is formed on a surface of a transparent support.

5. The display filter according to claim 1, further comprising a conductive mesh film which absorbs electromagnetic radiation emitted from the display device,
wherein the near-infrared radiation blocking layer is an adhesive layer adhered to the conductive mesh film.

6. The display filter according to claim 1, wherein the near-infrared radiation blocking layer further contains at least one of a color-compensation colorant and a neon-cut colorant.

7. A display filter used in a display device which can determine a touch position by detecting infrared radiation emitted from the display device, the display filter comprising:
a near-infrared radiation blocking layer which absorbs near-infrared radiation emitted from the display device,
wherein the near-infrared radiation blocking layer allows the near-infrared radiation emitted from the display device to have a transmittance of 30% or more at a wavelength range around 850 nm and a transmittance of 5% or less in a wavelength range of 950 nm or more.

8. The display filter according to claim 7, wherein the near-infrared radiation blocking layer comprises a polymer resin film that contains a near-infrared radiation absorbing colorant.

9. The display filter according to claim 7, wherein the near-infrared radiation blocking layer comprises a coating layer which is formed on a surface of a transparent support.

10. The display filter according to claim 7, further comprising a conductive mesh film which absorbs electromagnetic radiation emitted from the display device,
wherein the near-infrared radiation blocking layer is an adhesive layer adhered to the conductive mesh film.

11. The display filter according to claim 7, wherein the near-infrared radiation blocking layer further contains at least one of a color-compensation colorant and a neon-cut colorant.

12. A display device which can determine a touch position by detecting infrared radiation emitted from the display device, the display device comprising a display filter,
wherein the display filter comprises a near-infrared radiation blocking layer which absorbs near-infrared radiation emitted from the display device,
the near-infrared radiation blocking layer containing 1.5% by weight of a di-immonium-based colorant that absorbs near-infrared radiation.

13. The display device according to claim 12, wherein the display device is one selected from the group consisting of a plasma display panel, a liquid crystal display, and an organic light emitting display.

14. The display device according to claim 12, wherein the near-infrared radiation blocking layer allows the near-infrared radiation emitted from the display device to have a transmittance of 30% or more in a wavelength range of 850 nm and a transmittance of 5% or less in a wavelength range of 950 nm or more.

15. The display device according to claim 14, wherein the display device is one selected from the group consisting of a plasma display panel, a liquid crystal display, and an organic light emitting display.

16. A display device which can determine a touch position by detecting infrared radiation emitted from the display device, the display device comprising a display filter,
wherein the display filter comprises a near-infrared radiation blocking layer which absorbs near-infrared radiation emitted from the display device,
the near-infrared radiation blocking layer allowing the near-infrared radiation emitted from the display device to have a transmittance of 30% or more at a wavelength range around 850 nm and a transmittance of 5% or less in a wavelength range of 950 nm or more.

17. The display device according to claim 16, wherein the display device is one selected from the group consisting of a plasma display panel, a liquid crystal display, and an organic light emitting display.
